(19) United States
(12) Patent Application Publication
(10) Pub. No.: US 2011/0077975 A1
(43) Pub. Date: Mar. 31, 2011

(54) SYSTEM AND METHOD FOR RFID-ENABLED TRACKING OF INSURANCE CLAIMS PACKAGES AND PAYMENTS

(75) Inventors: Benjamin I. Schimelman, Middletown, CT (US); David M. Powers, Coventry, CT (US)

(73) Assignee: Hartford Fire Insurance Company, Hartford, CT (US)

(21) Appl. No.: 12/569,977

(22) Filed: Sep. 30, 2009

(51) Int. Cl. G06Q 40/00

(52) U.S. Cl. 705/4

(57) ABSTRACT

A computerized system for RFID-enabled tracking and automated processing of insurance claims packages includes a package generation module, a package dispatching module, a package receiving module, and a package check module. The system generates, processes, and tracks the processing status of RFID-tagged insurance claim packages. Each RFID-tagged insurance claim package includes at least one document with an associated RFID device encoded with information including an identifying indicator. The system modules query each associated RFID device to determine how each RFID-tagged insurance claim package should be handled.

### FIELD OF THE INVENTION

The present invention relates to insurance claims package processing and, more particularly, to computerized systems and methods for tracking and automated processing of insurance claims packages.

### BACKGROUND OF THE INVENTION

When an insured party suffers a loss covered by insurance, an insurance claim must be made and processed in order to obtain payment of the covered loss. Since timely payment of the claim will timely compensate the insured party's loss, it is highly desirable to expedite processing of insurance claims.

Typically, after paying an insurance claim, the paying insurance company will seek subrogation of payments made for covered losses. That is, the paying insurance company will try to collect the covered loss payment from the parties actually responsible for the loss, or from the insurers covering the responsible parties. Accordingly, it is highly desirable to expedite processing of subrogation claims.

However, insurance claims, and particularly subrogation claims, generally involve large quantities of documents collected into claim packages. During processing of an insurance claim or of a subrogation claim, each claim package is manually inspected and handled many times to determine what claim the claim package relates to and where the claim package should be sent. Repeated manual inspection and handling can significantly delay processing of the claim package. Accordingly, it is highly desirable to provide a method or system for automating the inspection and handling of insurance or subrogation claim packages.

### SUMMARY OF THE INVENTION

According to the present invention, a computerized system for RFID-enabled tracking and automated processing of insurance claims packages includes a package generation module configured to generate an RFID-tagged insurance claim package including at least one document with an associated RFID device, the package generation module being further configured to encode the associated RFID device with information including at least an identifying indicator. The computerized system also includes a package dispatching module configured to query the associated RFID device to obtain at least the identifying indicator, and configured to route the RFID-tagged insurance claim package to an associated respondent based on at least the identifying indicator.

According to the present invention, a method for RFID-enable tracking of insurance claim packages includes generating an RFID-tagged insurance claim package including at least one document with an associated RFID device; encoding the associated RFID device with information including at least an identifying indicator; and routing the RFID-tagged insurance claim package to an associated respondent based on at least the identifying indicator.

According to the present invention, an RFID-tagged insurance claim package includes at least one document including an associated RFID device encoded with claim information including at least an identifying indicator.

These and other objects, features and advantages of the present invention will become apparent in light of the detailed description of the best mode embodiment thereof, as illustrated in the accompanying drawings.

### BRIEF DESCRIPTION OF THE DRAWINGS

FIG. 1 is a schematic illustration of a computerized system for RFID-enabled tracking and automated processing of insurance claim packages, according to an embodiment of the present invention;

FIG. 2 is a schematic illustration of the system of FIG. 1, implemented using a network host computer;

FIG. 3 is a schematic illustration of the system of FIG. 1, implemented using a distributed network architecture;

FIG. 4 is a schematic illustration of an RFID-tagged insurance claim package for processing by the system shown in FIGS. 1 through 3; and

FIG. 5 is a flowchart illustrating a process for RFID-enabled tracking and automated processing of RFID-tagged insurance claim packages, as performed by the system shown in FIGS. 1 through 3.

### DETAILED DESCRIPTION OF PREFERRED EMBODIMENTS

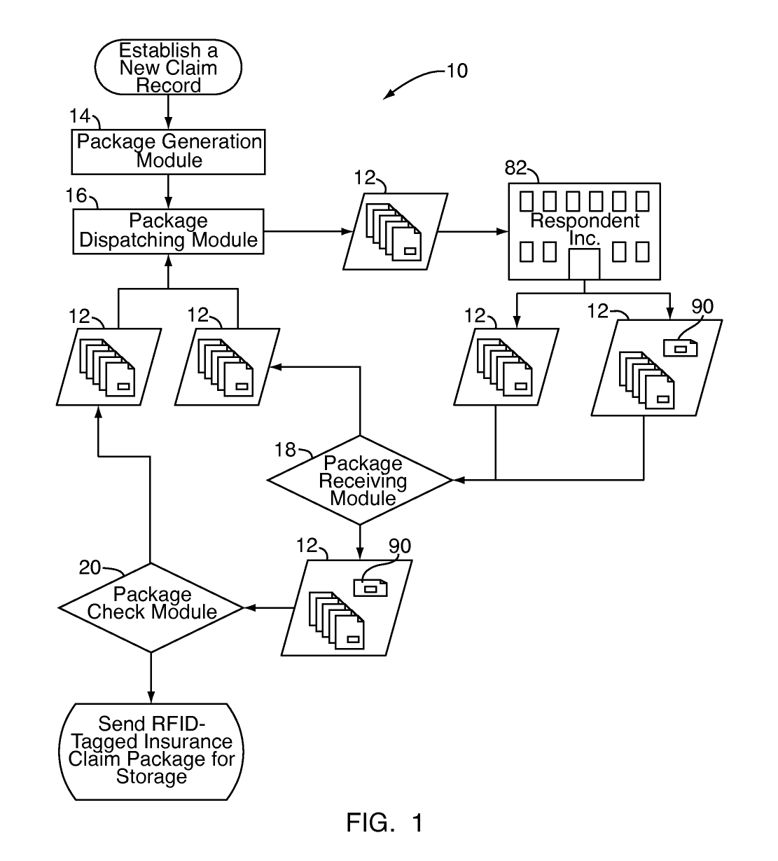

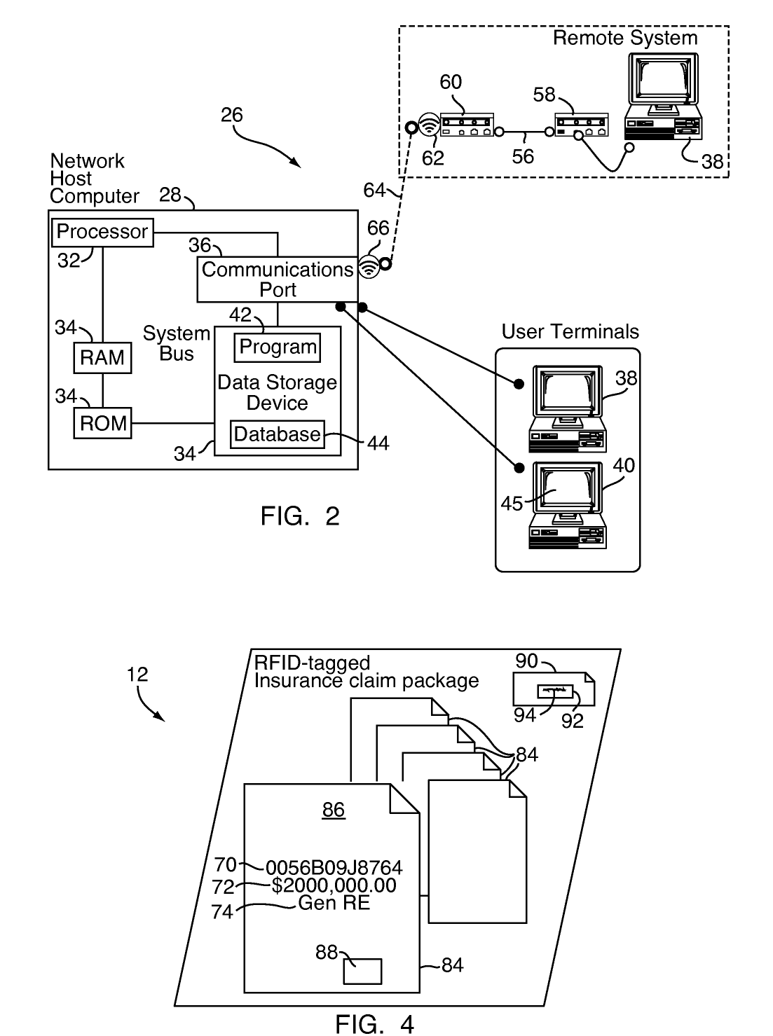

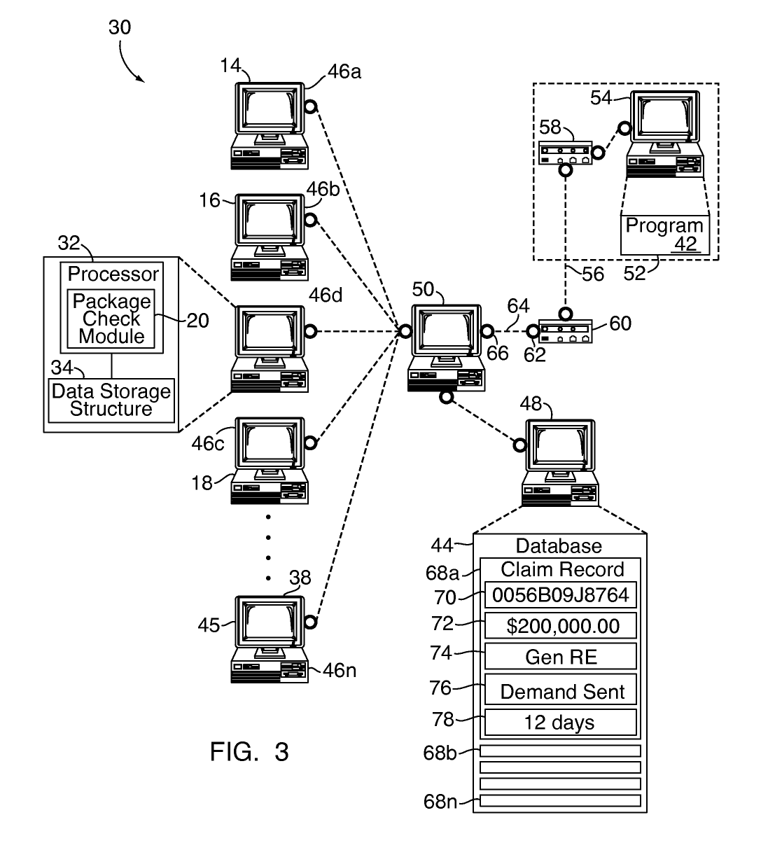

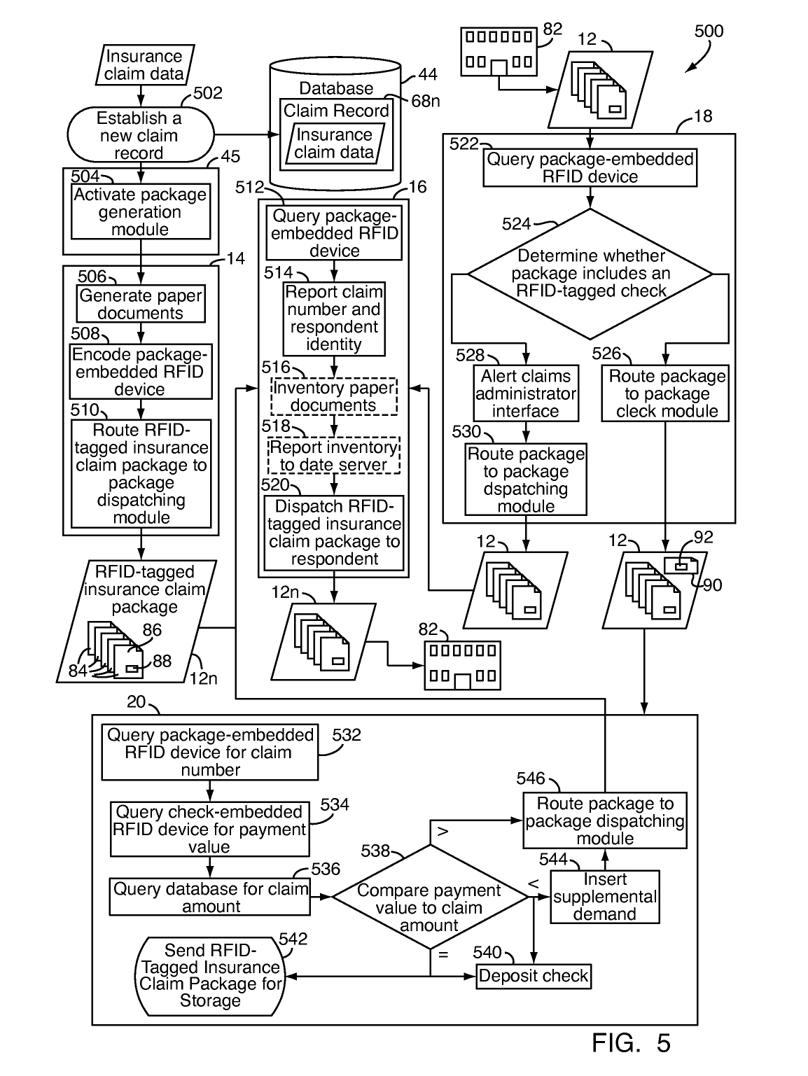

Referring to FIG. 1, a computerized system 10 for RFID-enabled tracking and automated processing of RFID-tagged insurance claim packages 12 includes a package generation module 14, a package dispatching module 16, a package receiving module 18, and a package check module 20. The computerized system 10 may be implemented in many different ways. For example, the computerized system 10 may be implemented in a central server architecture 26 that is centered on a conventional network host computer 28, as shown in FIG. 2. Alternatively, and preferably, the computerized system 10 can be implemented in a distributed network architecture 30, as shown in FIG. 3. The various modules of the computerized system 10 are configured to accomplish a process 500 for RFID-enabled tracking and automated processing of the insurance claim packages 12, as further discussed below in detail with reference to FIG. 5.

Referring to FIG. 2, the network host computer 28 includes at least one controller, processor, or central processing unit (CPU) 32, one or more data storage structures 34, and at least one communication port 36. The processor 32 may include one or more conventional microprocessors and one or more supplementary co-processors such as math co-processors. The communication port 36 may include multiple communication channels for simultaneous communication with, for example, other processors, servers or client terminals 38, or a display unit 40. Devices in communication with each other need not be continually transmitting to each other. On the contrary, such devices need only transmit to each other as necessary, may actually refrain from exchanging data most of the time, and may require several steps to be performed to establish a communication link between the devices. For example, the communication port 36 may include wire modems, wireless radio, infrared, visible laser, or UV laser transceivers, or audio transceivers. The communication port 36 and the one or more data storage structures 34 are in communication with the processor 32 to facilitate the operation of the network host computer 28. The data storage structures 34 may comprise an appropriate combination of magnetic, optical and/or semiconductor or flash memory, and may include, for example, RAM, ROM, an optical disc such as a compact disc and/or a hard disk or drive. The processor 32 and the data storage structures 34 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wireline medium.

At least one of the data storage structures 34 is encoded with (i) a program and/or algorithm(s) 42 (e.g., computer program code and/or a computer program product) adapted to configure one or more of the processors 32 to emulate the various modules of the computerized system 10, as described in detail hereinafter; and/or (ii) at least one database 44 configured to store information required, manipulated, or produced by the computerized system 10 in execution of the program 42.

The computer program 42 for configuring the processor 32 to implement the process 500 (and other functions described herein) can be developed by a person of ordinary skill in the art, and is not described in detail herein. Suitable computer program code may also be provided for performing numerous other functions such as generating notifications at selected time intervals. For example, in addition to instructions for configuring the processor 32 to perform the process 500, the program 42 also may include program elements such as an operating system, a database management system and “device drivers” that allow the processor to interface with computer peripheral devices (e.g., a video display, a keyboard, a computer mouse). The instructions of the program 42 may be read by the processor 32 from the data storage structures 34. The program 42 may be stored, for example, in a compressed, an uncompiled and/or an encrypted format, and may include computer program code. While execution of sequences of instructions in the program 42 will configure the processor 32 to emulate one or more of the modules 14, 16, 18, 20 for performing steps of the computerized process 500 as described below, hard-wired circuitry may be used in place of, or in combination with, software instructions for implementation of the computerized process 500. Thus, embodiments of the present invention are not limited to any specific combination of hardware and software.

Each user device or computer or client terminal 38 may include any one or a combination of a keyboard, a computer display, a touch screen, LCD, voice recognition software, an optical or magnetic read head, or other input/output devices required to implement the above functionality. Each display unit 40 may include any one or a combination of a computer display, a printer, a CD/DVD burner, a magnetic tape drive, a magnetic disk drive, an LCD array, a voice speaker, a network connection, or similar output device. At least one of the user devices or computers or client terminals 38, or of the display units 40, may be configured according to the computer program 42, or according to other instructions, to provide various user interfaces, such as a claims administrator interface 45.

Referring to FIG. 3, the distributed network architecture 30 includes several module servers 46a through 46n and at least one data server 48 connected by a communications hub 50. Each of the module servers 46a through 46n includes at least one associated processor 32 and one or more data storage structures 34. The data server 48 is configured to maintain the database 44 in response to instructions and queries received from the various module servers 46a through 46n, according to the program 42. The communications hub or port 50 serves as a primary communication link between the module servers 46, the data server 48, and other servers, client or user terminals 38 and related devices including one or more display units 40. The communications hub or port 50 may have minimal processing capability itself, serving primarily as a communications router, or may also act as another module server 46. A variety of communications protocols may be part of the system, including but not limited to: Ethernet, SAP, SAS™, ATP, Bluetooth, and TCP/IP.

In the distributed network architecture 30, as shown in FIG. 3, each of the module servers 46 is configured by execution of the program 42 to emulate one or more of the various modules of the system 10. For example, module servers 46a through 46d may be configured by the program 42 to emulate the package generation module 14, the package dispatching module 16, the package receiving module 18, and the package check module 20, respectively, at different physical locations throughout a mail handling facility, an office environment, or another workspace.

In the central server architecture 26 shown in FIG. 2 or in the distributed network architecture 30 shown in FIG. 3, the program 42 may be embodied in a computer-readable medium 52, other than any of the data storage structures 34, that provides or participates in providing instructions to the processor 32 (or any other processor of a computing device described herein) for execution. The computer-readable medium 52 may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Transmission media include coaxial cables, copper wire and fiber optics, including the wires that comprise a system bus coupled to the processor. Transmission media may carry acoustic or light waves, such as those generated during radio frequency (RF) and infrared (IR) data communications. Common forms of computer-readable media 52 include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave encoded with data by amplitude, phase, and/or frequency modulation, or any other medium from which a computer can read. Various forms of the computer-readable medium 52 may be involved in configuring the processor 32 (or any other processor of a device described herein) to perform the computerized process 500. For example, as shown in FIG. 3, the program 42 may initially be borne on a magnetic disk of a remote computer 54. The remote computer 54 can load the instructions into its dynamic memory and send the instructions over a telephone line 56 using a first modem 58. A second modem 60 local to the communications hub 50 can receive the data on the telephone line 56 and can use an infrared transmitter 62 to convert the data to a wireless signal 64. An infrared detector 66 of the communications hub 50 can receive the data carried in the wireless signal 64 and transfer the data through the communications hub 50 to one of the module servers 46 or to the data server 48. In addition, instructions may be received as electrical, electromagnetic, or optical signals, conveyed either on optical or electromagnetic cables or as wireless carrier waves that carry data streams representing various types of information.

In the central server architecture 26 shown in FIG. 2 or in the distributed network architecture 30 shown in FIG. 3, the claims administrator interface 45 is in communication with, and coordinates operation of, the various system modules 14, 16, 18, 20 and the data server 48. The claims administrator interface 45 also displays system status information to a user, and receives instructions from the user.

Referring specifically to FIG. 3, the data server 48 maintains the database 44, which includes a plurality of claim records 68a-n, each claim record 68 including fields related to an insurance claim, such as, for example, a claim number 70 or any other identifying indicator, a claim amount 72, a subrogation respondent identity 74, a respondent address 76, a processing status 78, and a claim age 80. The information contained in the fields of each claim record 68 may be provided to the data server 48 by the user via the claims administrator interface 45, may be reported to the data server 48 by one of the various system modules 14, 16, 18, 20, or may be otherwise determined. For example, the processing status 78 may be determined based on which system module 14, 16, 18, or 20 has most recently reported the claim number 70. The data server 48 can be configured by the program 42 to analyze the records 68, for example to determine an average of the claim ages 80, to monitor an aging trend for each RFID-tagged insurance claim package 12 at each value of the processing status 78, or to generate a distribution of claim ages 80 for each respondent identity 74. The data server 48 can be further configured by the program 42 to send trend information and alerts to the claims administrator interface 45. For example, the data server 48 can be configured to alert the claims administrator interface 45 if any of the RFID-tagged insurance claim packages 12 exceeds a predetermined threshold for claim age 80.

Referring to FIG. 4, each RFID-tagged insurance claim package 12 corresponds to one or more insurance claims having a common respondent 82. Each of the RFID-tagged insurance claim packages 12 includes one or more documents 84, and includes among the documents 84 a demand document 86 specifying the claim number(s) 70, the claim amount(s) 72, and the respondent identity 74 corresponding to one or more insurance claims. The documents 84 can also include, for example, a response document in addition to or in place of the demand document 86. The documents 84 are physical objects including, but not limited to, any or all of the following: a paper document, a floppy disk, a flexible disk, a hard disk, a magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge. The documents 84 include, but are not limited to, for example, outgoing or incoming demand letters, responses, settlement offers or counteroffers, evidentiary exhibits, inventories, appraisals, requests for information, or other correspondence, as produced by or modified by a demanding party or a claimant, by a respondent to an insurance claim, or by any third party to an insurance claim. At least one of the documents 84 includes an associated RFID device 88, such as, for example, a chip, tag, or imprinted circuit. Preferably, at least one of the associated RFID devices 88 is embedded into the demand document 86. Each of the associated RFID devices 88 can be write-once, or erasable/rewritable.

In operation, as shown in FIG. 5, the system 10 implements a computerized process 500 for tracking and automated processing of the RFID-tagged insurance claims packages 12. The computerized process 500 is initiated when a user of the system performs a step 502 of establishing a new claim record 68n in the database 44 via the claims administrator interface 45. The claims administrator interface 45 then performs a step 504 of instructing the package generation module 14 to generate a new RFID-tagged insurance claim package 12n. Throughout subsequent operations of the computerized system 10, the claims administrator interface 45 monitors the modules 14, 16, 18, 20 and the database 44 and alerts the user regarding, for example, changes to the processing status 78 of each RFID-tagged insurance claim package 12. The claims administrator interface 45 can monitor the system 10 continuously or by querying or pinging each of the modules 14, 16, 18, 20 at predetermined intervals. Alternatively, each of the modules 14, 16, 18, 20 can send an alert to the claims administrator interface 45 each time the module queries an associated RFID device in one of the RFID-tagged insurance claim packages 12. The data server 48 also can send alerts to the claims administrator interface 45, for example based on the claim ages 80 of the RFID-tagged insurance claim packages 12, as discussed above with reference to FIG. 3.

The package generation module 14 performs a step 506 of generating the documents 84 comprising the new RFID-tagged insurance claim package 12n; a step 508 of encoding the associated RFID device 88 of the new RFID-tagged insurance claim package 12n with some or all of the information from the new claim record 68n; and a step 510 of routing the new RFID-tagged insurance claim package 12n to the package dispatching module 16. In some embodiments, the associated RFID device 88 can be encoded with encrypted confidential information. Confidential information can include, but is not limited to, legal settlement offers, proprietary business information (trade secrets), medical diagnoses or treatments, individual identifying data such as a social security number or birth date, or other sensitive or legally-protected data. In embodiments where the associated RFID device 88 has been encoded with encrypted confidential information, the confidential information does not need to be included on any of the documents 84 within the RFID-tagged insurance claim package 12.

The package dispatching module 16 receives RFID-tagged insurance claim packages 12 from the package generation module 14, the package receiving module 18, and the package check module 20. For each RFID-tagged insurance claim package 12, the package dispatching module 16 performs a step 512 of querying the associated RFID device 88 to determine the claim number 70 and the respondent identity 74 and a step 514 of reporting the claim number 70 and the respondent identity 74 to the data server 48. In embodiments wherein more than one of the documents 84 includes an associated RFID device 88, the package dispatching module 16 also performs a step 516 of querying the associated RFID devices 88 to take an outgoing inventory of the RFID-tagged insurance claim package, and performs a step 518 of reporting the outgoing inventory to the data server 48. The package dispatching module 16 then performs a step 520 of dispatching the RFID-tagged insurance claim package 12 to the appropriate respondent 82.

The package receiving module 18 receives RFID-tagged insurance claim packages 12 from the respondents or from other parties. For each RFID-tagged insurance claim package 12, the package receiving module 18 performs a step 522 of querying the associated RFID device 88 and reporting the claim number 70 to the database server 48. The package receiving module 18 also performs a step 524 of determining which documents 84 within the RFID-tagged insurance claim package 12 include associated RFID devices 88, and taking an incoming inventory of the RFID-tagged insurance claim package 12 based on the associated RFID devices 88. As part of the incoming inventory, the package receiving module 18 determines whether the RFID-tagged insurance claim package 12 includes an RFID-tagged check 90 having a check-embedded RFID device 92. When the RFID-tagged insurance claim package 12 includes an RFID-tagged check 90, the package receiving module 18 performs a step 526 of routing the RFID-tagged insurance claim package 12 to the package check module 20. When the RFID-tagged insurance claim package 12 does not include an RFID-tagged check 90, the package receiving module 18 performs a step 528 of routing the RFID-tagged insurance claim package 12 back to the package dispatching module 16 and a step 530 of sending an alert to the claims administrator interface 45.

For each RFID-tagged insurance claim package 12 received from the package receiving module 18, the package check module 20 performs a step 532 of querying the associated RFID device 88 to obtain the claim number 70 of the RFID-tagged insurance claim package 12 and a step 534 of querying the check-embedded RFID device 92 to obtain a payment value 94 of the RFID-tagged check 90. The package check module 20 also performs a step 536 of querying the database server 48, or the associated RFID device 88, to obtain the claim amount 72 corresponding to the claim number 70. The package check module 20 also performs a step 538 of comparing the claim amount 72 to the payment value 94. When the payment value 94 is equal to the claim amount 72, the package check module 20 performs a step 540 of depositing the RFID-tagged check 90 and a step 542 of sending the RFID-tagged insurance claim package 12 for storage. When the payment value 94 is less than the claim amount 72, the package check module 20 performs the step 540 of depositing the RFID-tagged check 90 and a step 544 of inserting a supplemental demand 96 into the RFID-tagged insurance claim package 12, then performs a step 546 of routing the RFID-tagged insurance claim package 12 back to the package dispatching module 16. When the payment value 94 exceeds the claim amount 72, the package check module 20 performs the step 546 of routing the RFID-tagged insurance claim package 12 back to the package dispatching module 16.

One advantage of the present invention is that the RFID-tagged insurance claim package 12 can be easily tracked by the system 10, so that the processing status 78 of each RFID-tagged insurance claim package 12 can be reliably updated in the database 44. Thus, each RFID-tagged insurance claim package 12 can easily be located based on the corresponding processing status 78.

Another advantage of the present invention is that, by providing alerts to the user based on monitoring the modules 14, 16, 18, 20 and the database 44, the claims administrator interface 45 can prompt expedited processing of any RFID-tagged insurance claim package 12 that might otherwise be delayed in handling. Additionally, through analysis of the claim records 68, the data server 48 can provide actionable performance statistics regarding each respondent 82 (for example, the respondent's average time to provide payment on an RFID-tagged insurance claim package), enabling accurate business decisions.

A further advantage of the present invention is that each RFID-tagged check 90 can be automatically processed by the system 10 so that the RFID-tagged insurance claim package 12 can be appropriately routed.

Yet another advantage of the present invention is that the associated RFID device can be encoded with encrypted confidential information not otherwise present in the RFID-tagged insurance claim package, thereby enhancing the protection of sensitive data.

Another advantage of the present invention is that the RFID-tagged insurance claim package can include multiple documents, each document having an associated RFID device encoded with document identifiers, such that an inventory of the documents can be accomplished by querying the associated RFID devices.

Although this invention has been shown and described with respect to the detailed embodiments thereof, it will be understood by those skilled in the art that various changes in form and detail thereof may be made without departing from the spirit and the scope of the invention.

For example, automated mail handling equipment can be incorporated into the system 10 for operation by the various modules of the system 10. The modules of the system 10 can be grouped together or further subdivided. Each RFID-tagged insurance claim package 12 can include a single insurance claim, or aggregate claims. The system 10, including the data server 48, can be placed in communication with similar systems maintained by other parties. The data server 48 can be implemented within the network host computer 28. Other variations will be apparent to those skilled in the art.

What is claimed is:

1. A computerized system for RFID-enabled tracking and automated processing of insurance claims packages comprising:
a package generation module configured to generate an RFID-tagged insurance claim package including at least one document with an associated RFID device, and configured to encode the associated RFID device with information including at least an identifying indicator; and
a package dispatching module configured to query the associated RFID device to obtain at least the identifying indicator, and configured to route the RFID-tagged insurance claim package to an associated respondent based on at least the identifying indicator.

2. The system according to claim 1, further comprising:
a claims administrator interface in communication with at least the package generation module and the package dispatching module, wherein the claims administrator interface alerts a user regarding a change to a processing status of the RFID-tagged insurance claim package.

3. The system according to claim 2, wherein the package dispatching module alerts the claims administrator interface after receiving the RFID-tagged insurance claim package.

4. The system according to claim 1, further comprising:
a package check module configured to receive an RFID-tagged check, to query the RFID-tagged check for a payment value, to obtain a claim value associated with an insurance claim corresponding to the RFID-tagged check, to compare the payment value to the claim value, and to return the RFID-tagged check to an associated respondent in the case where the payment value of the RFID-tagged check exceeds the claim value of the insurance claim associated with the RFID-tagged check.

5. The system according to claim 4, wherein the package check module alerts the claims administrator interface after comparing the payment value of the RFID-tagged check to the claim value associated with the insurance claim corresponding to the RFID-tagged check.

6. The system according to claim 4, further comprising:
a package receiving module configured to receive RFID-tagged insurance claim packages and to forward to the package check module each received RFID-tagged insurance claim package that contains an RFID-tagged check.

7. The system according to claim 6, wherein each of the package generation module, the package dispatching module, the package receiving module, and the package check module alerts the claims administrator interface after querying the associated RFID device.

8. The system according to claim 6, wherein the RFID-tagged insurance claim package includes a plurality of documents, wherein some of the plurality of documents include a corresponding associated RFID device, and wherein the package receiving module is configured to take an incoming inventory of each RFID-tagged insurance claim package and to compare the incoming inventory of each RFID-tagged insurance claim package to the outgoing inventory of each RFID-tagged insurance claim package.

9. The system according to claim 1, wherein the RFID-tagged insurance claim package includes a plurality of documents, and wherein some of the plurality of documents include a corresponding associated RFID device.

10. The system according to claim 9, wherein the package dispatching module is configured to determine how many associated RFID devices are present in the RFID-tagged insurance claim package, and to take an outgoing inventory of the RFID-tagged insurance claim package in the case that more than one associated RFID device is present.

11. The system according to claim 1, wherein the package generation module is further configured to encode the associated RFID device with encrypted confidential information.

12. The system according to claim 11, wherein the encrypted confidential information is not otherwise included in the RFID-tagged insurance claim package.

13. The system according to claim 12, wherein the encrypted confidential information includes at least one of medical records, legal settlement offers, and proprietary business data.

14. A computer-implemented method for RFID-enable tracking of insurance claim packages comprising:
generating an RFID-tagged insurance claim package including at least one document with an associated RFID device;
obtaining from a database server an identifying indicator associated with an insurance claim;
encoding the associated RFID device with information including at least the identifying indicator;
electronically querying the associated RFID device; and
routing the RFID-tagged insurance claim package to an associated respondent based on at least the identifying indicator.

15. The method according to claim 14, further comprising:
electronically querying a check-embedded RFID device to determine a payment value of an RFID-tagged check;
obtaining a claim value associated with an insurance claim corresponding to the RFID-tagged check;
automatically comparing the payment value of the RFID-tagged check to the claim value of the RFID-tagged insurance claim package; and
automatically routing the RFID-tagged check based on the comparison of the payment value to the claim value.

16. The method according to claim 15, wherein the RFID-tagged insurance claim package includes more than one document, wherein more than one document includes a corresponding associated RFID device, and wherein the step of electronically querying the associated RFID device includes taking an inventory of the documents including the associated RFID devices.

17. The method according to claim 15, further comprising:
automatically alerting a user after comparing the payment value to the claim value.

18. The method according to claim 14, wherein the step of encoding the associated RFID device includes encoding the associated RFID device with encrypted confidential information.

19. An RFID-tagged insurance claim package comprising:
at least one document including an associated RFID device encoded with claim information including at least an identifying indicator.

20. The RFID-tagged insurance claim package according to claim 19, further comprising:
an RFID-tagged check including a check-embedded RFID device.

21. The RFID-tagged insurance claim package according to claim 19, wherein the claim information includes encrypted confidential information.
